(19) United States
(12) Patent Application Publication
(10) Pub. No.: US 2006/0146516 A1
(43) Pub. Date: Jul. 6, 2006

(54) LED light source structure

(75) Inventors: Hung-Chun Li, Pingtung Hsien (TW); Li-Ling Lee, Hsinchu Hsien (TW); Wen-Lune Wu, Changhua Hsien (TW)

Correspondence Address: LOWE HAUPTMAN BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, Hsinchu Hsien (TW)

(21) Appl. No.: 11/315,260

(22) Filed: Dec. 23, 2005

(30) Foreign Application Priority Data
Dec. 31, 2004 (TW) 093141804

(51) Int. Cl. F21V 9/16; F21V 5/00

(52) U.S. Cl. 362/84; 362/246; 362/231

(57) ABSTRACT

A light emitting diode (LED) light source structure comprises a base, and there is a notch extending from a surface to the inside of the base. At least one LED disposed in the notch is used to be a light source, and a conductive wire for providing the power is also disposed in the notch and connected with the LED. The top of the notch is covered by a diffusing layer for uniformly diffusing the light radiated from the LED.

### RELATED APPLICATIONS

The present application is based on, and claims priority from, Taiwan Application Serial Number 93141804, filed Dec. 31, 2004, the disclosure of which is hereby incorporated by reference herein in its entirety.

### BACKGROUND

1. Field of Invention

The present invention relates to a light source structure. More particularly, the present invention relates to a light source structure for the light emitting diode (LED).

2. Description of Related Art

Lamplight applications are ubiquitous in industry, such as in vehicle lighting, television and computer screen displays, and indicator lights of industrial instruments. Different light source techniques are depended upon to provide different kinds of light for satisfying different application requirements.

Traditionally, light bulbs have been the most general light source. Many light bulb and fluorescent tube defects have gradually become apparent when miniaturizing and varying them for lamp and lantern applications. For example, the light bulbs and fluorescent tubes on a large-sized or high-brightness apparatus consumes considerable power and generate much heat, and the light bulbs and fluorescent tubes which are able to provide high brightness usually contain hazardous environmental pollutants, such as mercury.

Moreover, light bulbs and fluorescent tubes have other drawbacks of having large volume, being fragile and having low color variation for miniature apparatuses, especially portable devices. Additionally, light bulbs and fluorescent tubes are usually made of glass, making them easily damaged by violent shaking and impacts. Furthermore, the color of the light radiated from the light bulbs and fluorescent tubes cannot be substantially varied.

Many of these drawbacks are overcome by the light emitting diode (LED); the LED has a more variable volume, a lower power consumption (a lower driving current), a lower heat generation and many available colors (wavelength) of light that can be chosen. Thus, the LED has become increasingly more popular in vehicle lantern applications. However, the luminous intensity of the LED is lower than the light bulb and the fluorescent tube under the same power consumption; therefore, how to effectively make good use of the light radiated from the LED is very important.

FIG. 1 shows a conventional LED lantern structure. The lantern comprises two light source structures 102, each of which comprises an LED 104, two power conductors 106, a condensing lens 108 and a radiating cover 110. The LED 104 acts as the light source of the lantern. The condensing lens 108 is used to gather the light dispersed from the LED 104 and focus a light 112 toward the top of the figure. The power conductors are used to provide the power needed by the LED 104. The radiating cover 110 is used to protect the LED 104.

The foregoing lantern structure still has some problems. First, the heat generated by the LED 104 cannot be dissipated easily since the radiating cover 110 material is resin with a low heat conductivity. Therefore, the radiating rate in the radiating cover 110 is very slow, indirectly causing the life span of the LED 104 to be shortened. Second, it is impossible to dispose many LEDs in the light source 102 due to the aforementioned problem of radiating, so the utilization of space in the radiating cover 110 cannot be improved. Thus, it is impossible to form many LEDs with different colors in the radiating cover 110 for color mixing. Third, the scope of light irradiation depends on the angle of the condensing lens 108 and cannot be further adjusted. Fourth, the fabrication cost is high since every LED 104 needs a radiating cover 110.

According to the foregoing shortcomings, a more economical and more efficient LED light structure is needed.

### SUMMARY

It is therefore an objective of the present invention to provide an LED light source structure with a higher radiating rate.

It is another objective of the present invention to provide an LED light source structure with a higher utilization of space.

It is still another objective of the present invention to provide an LED light source structure with a higher brightness.

It is another objective of the present invention to provide an LED light source structure with a higher flexibility of optical design.

It is still another objective of the present invention to provide an LED light source structure with a lower fabricating cost.

It is another objective of the present invention to provide an LED light source structure with a smaller volume.

In accordance with the foregoing and other objectives of the present invention, the light source structure comprises a base with a notch, wherein there are at least one LED and one conductive wire used to provide power for the LED. The color of the LEDs disposed in the notch may all be the same or all different. Finally, there is a diffusing layer over the top of the notch for uniformly diffusing the light, wherein the interface between the diffusing layer and the space in the notch can be designed as a plane surface or a curved surface for generating different diffusing patterns.

### BRIEF DESCRIPTION OF THE DRAWINGS

These and other features, aspects, and advantages of the present invention will become better understood with regard to the following description, appended claims, and accompanying drawings where:

FIG. 1 illustrates a conventional LED light source structure;

FIG. 2 illustrates a cross-sectional view of the LED light source structure in accordance with an embodiment of the present invention;

FIG. 3 illustrates a cross-sectional view of the LED light source structure in accordance with another embodiment of the present invention; and

FIG. 4 illustrates a top view of the LED light source structure in accordance with an embodiment of the present invention.

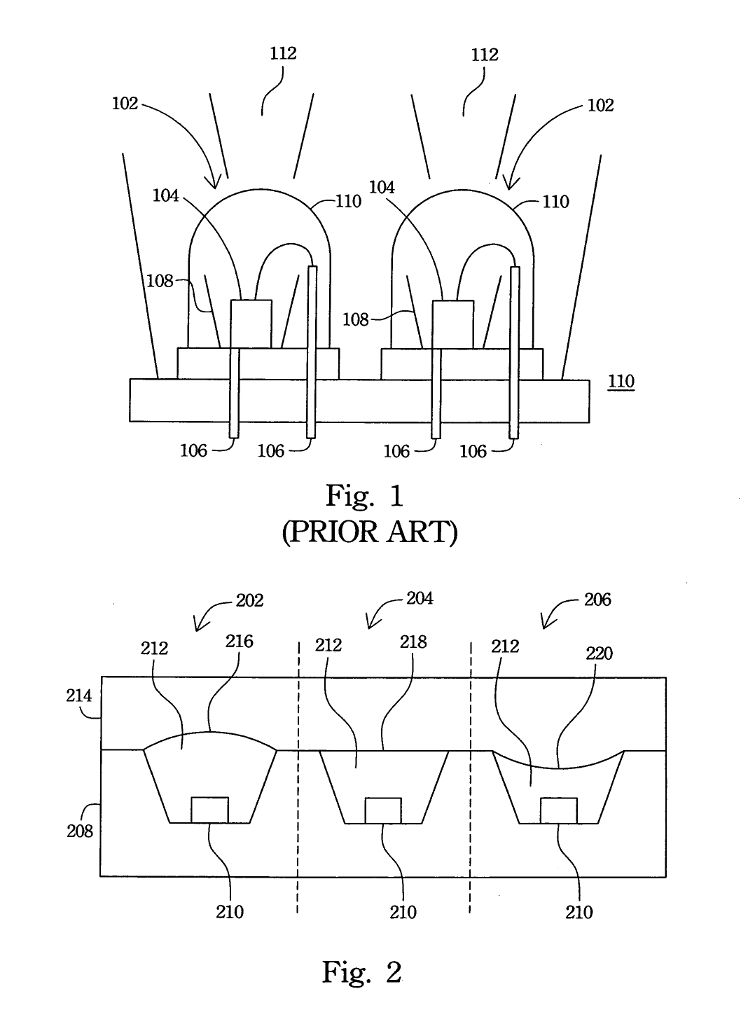

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The basic concept of the present invention is to directly dispose the LED of a light source structure on a base with a better radiating ability such that the light source structure volume is able to contain more LEDs with the same or different colors. Thus, the design of the light source structure is made more flexible, and the volume of the light source structure can be reduced.

FIG. 2 shows three kinds of the light source according to an embodiment of the present invention. Light source structures 202, 204 and 206 all comprise a base 208, an LED 210, a notch 212 and a diffusing layer 214. In general, the material of the base 208 has a bearing capacity that allows for conductive wire to be formed on it, such as provided by aluminum, ceramic or printed circuit board (PCB). There is at least one notch 212 extending from a surface of the base 208 into the inside of the base 208. The shape of the notch 212 may be a circular form, a square form or any irregular form, and is not limited by the embodiment. The base 208 and the notch 212 may be formed as one piece.

The LED 210 with any color may be mounted on the surface of the notch 212 by any mounting technique. The conductive wire (not shown in the figure) is also formed on the surface of the notch 212 by any wiring technique to provide power to the LED 210.

There is a diffusing layer 214 over the base 208 and the notch 212 such that the light emitted outwardly from the LED 210 passes through the diffusing layer 214 first. The purpose of the diffusing layer 214 is to diffuse the light emitted from the LED 210 from a dot to an area for broadening the irradiating scope. In this embodiment, the diffusing layer 214 may be a diffusing film used in a liquid crystal display (LCD) panel and made of a material such as resin.

The most obvious distinction among the light source structures 202, 204 and 206 is the interface between the notch 212 and the diffusing layer 214. It can be seen from FIG. 2 that there are three interfaces 216, 218 and 220 between the notch 212 of the light source structures 202, 204 and 206 and the diffusing layer 214, respectively. The interface 216 is concave, the interface 218 is flat and the interface 220 is convex. Different light source effects can be achieved by the different interface patterns. When light emitted from the LED 210 passes through the concave interface 216, the light is diffused, producing a light source with a larger scope. When light emitted from the LED 210 passes through the flat interface 218, the light is straightly emitted, producing a light source with a normal scope. When light emitted from the LED 210 passes through the convex interface 220, the light converges, producing a light source with a smaller scope. Thus, the shape and tortuosity of the interface between the notch and diffusing layer can be determined according to the practical requirements.

Furthermore, light propagating media may be filled into the notch 212 to obtain more variations of optical diffusion or convergence by varying the refracting effect of the interface between the notch 212 and diffusing layer 214. The medium filled into the notch 212 may be any solid, liquid or gaseous material that allows passage of light. Phosphors may also be filled into the notch 212 for varying the color of the light emitted from the LED 210.

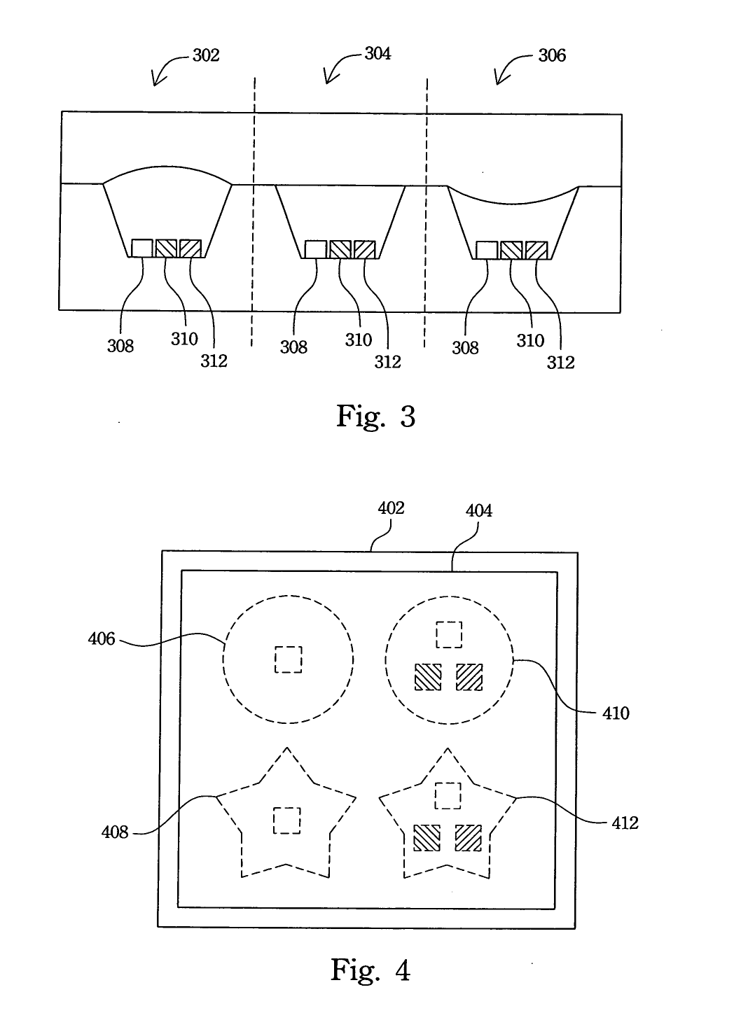

FIG. 3 illustrates another embodiment of the present invention, which describes three LED light source structures 302, 304 and 306. The light source structures 302, 304 and 306 are similar to the light source structures 202, 204 and 206, except that the number of LEDs in the notch is increased from one to a plurality of LEDs 308, 310 and 312. The color of the LEDs 308, 310 and 312 may be the same for enhancing the brightness, or may be different, such as when the colors of the LEDs 308, 310 and 312 are red, blue and green, respectively, for generating multiple colors by color mixing. The operation of color mixing may be carried out by a color controller.

Certainly, if there are several LEDs disposed in the notch, some of the LEDs can have one color and the rest can have another color. Because the plurality of LEDs is disposed in the same notch and not enclosed by the radiating covers separately, the spatial density of the LEDs and the luminous intensity in a unit area can be substantially enhanced.

FIG. 4 is a top view of some embodiments according to the present invention. A base 402 bears light source structures 406, 408, 410 and 412, and a diffusing layer 404 is used to cover these light source structures. The number of light source structures formed on a base is not limited by the embodiment in practice, but depends on the requirements and fabricating techniques.

The forms of the light source structures 406, 408, 410 and 412 are various and flexible in design. Both the light source structures 406 and 408 have only one LED, but the notch of the light source structure 406 is a circular form and the notch of the light source structure 408 is a star form, so the light source structures 406 and 408 are able to provide different visual effects. The forms of the light source structures 410 and 412 are identical to the light source structures 406 and 408 respectively, except that the light source structures 410 and 412 comprise many LEDs with the same or different colors, so they are able to provide more brightness and more color variation. The forms of the light source structures described herein are not limited in practice; more optical variations may be obtained by the aforementioned methods, such as filling media into the notch and varying the tortuosity of the interface between the notch and diffusing layer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light emitting diode (LED) light source structure, comprising:
a base, wherein said base comprises a notch extending from a surface of said base to the inside of said base;
at least one conductive wire disposed on a surface of said notch;
at least one LED disposed on the surface of said notch, wherein said LED is connected with said conductive wire; and
a diffusing layer over said notch.

2. The light source structure of claim 1, wherein the material of said base is aluminum, ceramics or printed circuit board (PCB).

3. The light source structure of claim 1, wherein said base and said notch are formed as one piece.

4. The light source structure of claim 1, wherein the material of said diffusing layer is resin.

5. The light source structure of claim 1, wherein the interface between said notch and said diffusing layer is flat or curved.

6. The light source structure of claim 1, further comprising a medium in said notch for varying the refractive index of the space within said notch.

7. The light source structure of claim 1, further comprising a phosphor in said notch.

8. The light source structure of claim 1, wherein when the number of said LEDs is more than two, said LEDs all have the same color or different colors.

9. A light emitting diode (LED) light source structure, comprising:
a base, wherein said base comprises a notch extending from a surface of said base to the inside of said base;
at least one conductive wire disposed on a surface of said notch;
at least one LED disposed on the surface of said notch, wherein said LED is connected with said conductive wire; and
a diffusing layer over said notch,
wherein the interface between said notch and said diffusing layer is flat or curved.

10. The light source structure of claim 9, wherein the material of said base is aluminum, ceramics or printed circuit board (PCB).

11. The light source structure of claim 9, wherein said base and said notch are formed as one piece.

12. The light source structure of claim 9, wherein the material of said diffusing layer is resin.

13. The light source structure of claim 9, further comprising a medium in said notch for varying the refractive index of the space within said notch.

14. The light source structure of claim 9, further comprising a phosphor in said notch.

15. The light source structure of claim 9, wherein when the number of said LEDs is more than two, said LEDs all have the same color or different colors.

16. A method for forming an LED light source structure, comprising:
providing a base, wherein said base comprises a notch extending from a surface of said base to the inside of said base;
disposing at least one conductive wire on a surface of said notch;
disposing at least one LED on the surface of said notch, wherein said LED is connected with said conductive wire; and
covering a diffusing layer over said notch.

17. The method of claim 16, wherein the material of said base is aluminum, ceramics or printed circuit board (PCB).

18. The method of claim 16, wherein said base and said notch are formed as one piece.

19. The method of claim 16, wherein the material of said diffusing layer is resin.

20. The method of claim 16, further comprising a step of curving the interface between said diffusing layer and said notch before said covering step.

21. The method of claim 16, further comprising a step of filling a medium into said notch before said covering step for varying the refractive index of the space within said notch.

22. The method of claim 16, further comprising a step of filling a phosphor into said notch before said covering step.

23. The method of claim 16, wherein when the number of said LEDs is more than two, said LEDs all have the same color or different colors.
